(19) United States
(12) Patent Application Publication
(10) Pub. No.: US 2006/0243328 A1
(43) Pub. Date: Nov. 2, 2006

(54) Flow control apparatus

(76) Inventor: Raymond L. Bessmertny, Lafayette, LA (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/116,223

(22) Filed: Apr. 28, 2005

(51) Int. Cl. G05D 7/06

(52) U.S. Cl. 137/487.5

(57) ABSTRACT

A flow control apparatus including a housing having an enclosure and a lid being hingedly attached to the enclosure so as to cover the top of the enclosure. A device is positioned away from the housing and has a pair of operating states, e.g., open and closed for a valve. A CPU is positioned within the enclosure and is adapted to toggle the remote device between its operating states. A sensor is connected to a system, of which the remote device forms a part, for conveying to the CPU information about an operating characteristic of the system. A keypad is mounted atop the enclosure for inputting the preferred operating parameters of the system into the CPU. A display is also mounted atop the enclosure for visually confirming the operating parameters of the system input into the CPU. A solar panel is mounted atop the lid for powering the apparatus. In response to receiving information from the sensor, the CPU determines whether the operating characteristic described by the information falls within the preferred operating parameters input into the CPU and, if not, the CPU toggles the device from one operating state to the other.

### FIELD OF THE INVENTION

The present invention relates generally to wells and, more particularly, to automatic apparatus including means to sense a condition that may or may not be present or may occur spasmodically, and that cause the operation of a well control device, without the intervention of a human operator.

### BACKGROUND OF THE INVENTION

It is often necessary to shut-in a flowing, oil or gas well to prevent equipment damage and fluid spills. Today, valves that operate automatically in response to downstream pressures often perform this task. A pressure being above a preset limit could indicate a broken compressor and continued flow to the compressor could rupture its suction line. A pressure being below a preset limit, however, might be caused by a fluid leak. In either case, fluid flow from a well must be ceased until the problem can be checked and repaired.

Many automatic valves for shutting-in a well include a battery-operated CPU that compares downstream pressures with a set pressure range to determine when a valve will be closed. As batteries deteriorate with the passage of time, the CPUs that they power loose their processing capabilities. Unintended well shut-ins and losses of hydrocarbon production can result of a power outage from a failed battery. Unfortunately, the replacement of batteries in an oilfield can be time-consuming and can divert resources away from more pressing needs.

### SUMMARY OF THE INVENTION

In light of the problems associated with the known equipment for shutting-in a flowing, oil or gas well, it is a principal object of the invention to provide a solar-powered apparatus for sensing pressures downstream of a well and, without the intervention of a human operator, closing a well shut-in valve in the event that sensed pressures fall outside of a predetermined range. The pressure range is fixed by a human operator upon setting up the apparatus, but can be selectively varied as operating conditions for the well change.

It is another object of the invention to provide a flow control apparatus of the type described that is easy to set up and use, requiring neither special tools nor prolonged training to accomplish such tasks. While the apparatus is especially useful to the operators of oil and gas wells, it can also be employed in other systems where a product flows through a conduit from a discrete source at a predetermined pressure.

It is a further object of the invention to provide a flow control apparatus of the type described that can be operated in an “override mode” in the event that a sensed pressure falling outside of a predetermined range is encountered and a shut-in valve is closed. In override mode, the shut-in valve is reopened and flow through the shut-in valve is continued. The reopened, shut-in valve is automatically closed in the event that a sensed pressure falling outside of a second, predetermined, pressure range that includes and exceeds the first one.

It is still another object of the invention to provide a flow control apparatus of the type described that car reopen a shut-in valve automatically in the event that the sensed pressure falls within a predetermined range set by a user.

It is an object of the invention to provide improved elements and arrangements thereof in a flow control apparatus for the purposes described that is compact in size, lightweight in construction, inexpensive to manufacture, and dependable in use.

Briefly, the flow control apparatus in accordance with this invention achieves the intended objects by featuring a shut-in valve for regulating the passage of a fluid through a flow line. A weather-resistant housing is positioned at a distance from the shut-in valve. The housing has an enclosure and a lid hingedly attached to the enclosure so as to cover the top thereof. A CPU is positioned within the enclosure and is adapted to remotely control the shut-in valve. A pressure transducer is also positioned within the enclosure and is in fluid communication with the flow line for sending to the CPU an electrical signal proportional to the pressure of the fluid. A keypad is mounted atop the enclosure for inputting a pressure range into the memory of the CPU. An LCD display is also mounted atop the enclosure for visually confirming the pressure range input into the CPU. A solar panel is mounted atop the lid for powering the apparatus. In response to receiving a signal from the pressure transducer, the CPU determines whether the pressure represented by the signal falls within the pressure range input into the CPU and, if not, the CPU closes the shut-in valve.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a schematic diagram of a flow control apparatus in accordance with the present invention.

FIG. 2 is a perspective view of the weather-resistant housing of the flow control apparatus of FIG. 1 taken from the front with its lid closed.

FIG. 3 is a perspective view of the weather-resistant housing of the flow control apparatus taken from the rear with its lid closed.

FIG. 4 is a perspective view of the weather-resistant housing of the flow control apparatus taken from the front with its lid in an open condition to expose the keypad and LCD display.

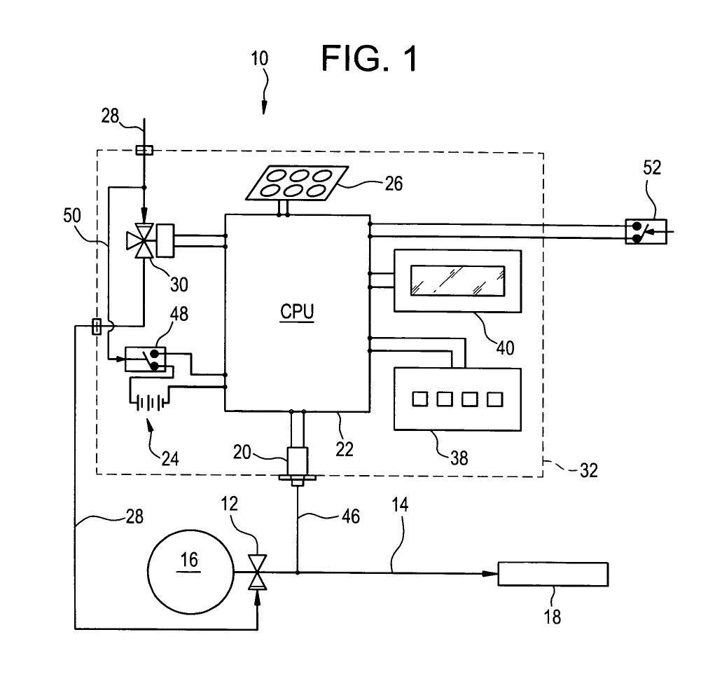

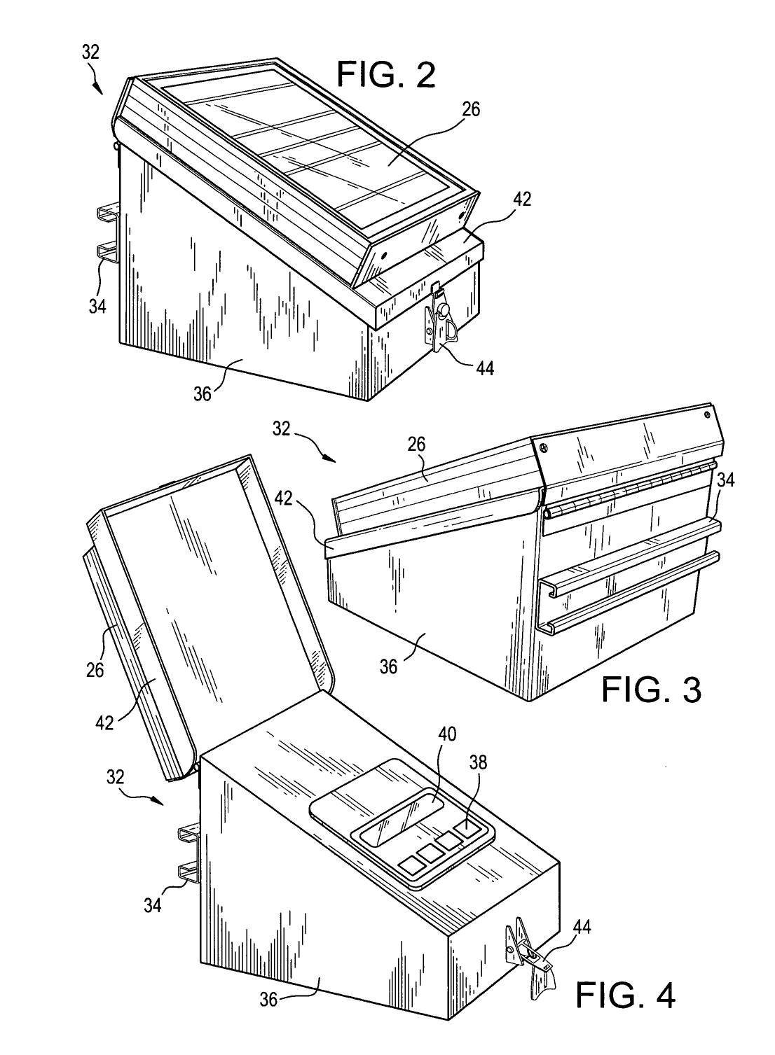

Similar reference characters denote corresponding features consistently throughout the accompanying drawings.

### DETAILED DESCRIPTION OF THE PREFERRED EMBODIMENT

Referring now to the FIGS., a flow control apparatus in accordance with the present invention is shown at 10. Apparatus 10 includes a shut-in valve 12 positioned on a flow line 14 connecting a pressurized fluid source 16 to a fluid receiver 18. A pressure transducer 20 is connected to flow line 14 downstream of shut-in valve 12 for gauging the pressure of fluid traveling from source 16 to receiver 18. Transducer 20 is connected to a CPU 22 that, in the event that pressures gauged by transducer 20 fall outside preset high and low limits, closes shut-in valve 12. A battery 24, recharged by a solar panel 26, powers apparatus 10.

Shut-in valve 12 is of manumatic-type, opening to permit fluid flow in flow line 14 only when charged with a small volume of compressed gas from a supply conduit 28. When shut-in valve 12 is closed, fluid cannot travel through flow line 14 from source 16 to receiver 18.

CPU 22 is connected to a solenoid valve 30 that controls the flow of compressed gas in supply conduit 28 and, therefore, controls the operation of shut-in valve 12. With the delivery of a first electrical signal from CPU 22, valve 30 opens to permit the flow of a small volume of compressed gas through a supply conduit 28 to shut-in valve 12 thereby opening shut-in valve 12. However, when a second signal is delivered from CPU 22 to solenoid valve 30, solenoid valve 30 closes to bleed compressed gas from supply conduit 28 downstream of solenoid valve 30 thereby closing shut-in valve 12.

In normal use of apparatus 10, pressurized fluid source 16 is a wellhead from which fluids: oil, gas and, perhaps, water flow under pressure. These fluids are conveyed away from the wellhead via flow line 14 that is normally a pipe. The pipe is connected to receiver 18 that ordinarily is: a tank, a separator, a pipeline, a compressor, or a refining facility. Nonetheless, it is to be understood that apparatus 10 can be employed in a variety of settings that are not related to producing oil and gas wells and can include any facility where fluids are moved through flow lines at rates and pressures sufficient to damage property or harm workers if not contained.

Transducer 20, CPU 22, and solar panel 26 are contained in/on a weather-resistant housing 32 capable of mounting upon a vertical support by means of support rails 34. Housing 32 includes a box-like enclosure 36 within which is positioned transducer 20 and CPU 22. Mounted atop enclosure 36 is a keypad 38 for inputting information into CPU 22, as will be described more fully below, and an LCD display 40 for confirming the input information. A lid 42, for covering keypad 38 and display 40 when they are not in use, is hingedly attached to enclosure 36. As shown, solar panel 26 is mounted atop lid 42 that is normally retained in a closed condition to protect keypad 38 from tampering by a lockable latch 44.

Pressure transducer 20 is placed in fluid communication with flow line 14 by means of a length of tubing 46. Upon receiving pressurized fluid from flow line 14 via tubing 46, transducer 20 produces a direct electrical current signal from 1 to 5 volts that is proportional to the received pressure and delivers the signal to CPU 22 for processing. It would not be unusual for transducer 20 to have a capability to measure pressures ranging from 0 to 10,000 psi although lower pressures and smaller pressure ranges could also be gauged should a user so desire. To permit accurate calibration of transducer 20 regardless of the range of pressures to be measured, it is expected that transducer 20 will be in communication with the atmosphere at the time that CPU 22 is initially energized.

The electrical components of apparatus 10 like: transducer 20, CPU 22, solenoid valve 30, keypad 38, and display 40 are ultimately powered by a solar panel 26 rated at 5-watts. Solar power that is not immediately consumed by apparatus 10 is stored in a 12-volt battery 24 that is adapted to be charged by solar panel 26. When there is insufficient sunlight to power apparatus 10, electrical current is drawn from battery 26 to make up the deficit.

A low-power switch (not shown) is connected to battery 24 that closes solenoid valve 30, and consequently closes shut-in valve 12, in the event that voltage in battery 24 reaches a predetermined minimum. The low-power switch, therefore, makes apparatus 10 failsafe by ensuring that shut-in valve 12 closes prior to any high- or low-pressure event in flow line 14.

A pressure switch 48 is employed to connect battery 24 to CPU 22. As shown, pressure switch 48 is connected by a length of tubing 50 to supply conduit 28 used to operate shut-in valve 12. Only when compressed gas presses against a movable element within switch 48, will switch 48 close to permit apparatus 10 to be energized. Thus, battery 24 can be charged at the time of manufacture of apparatus 10 and shipped to a user without battery 24 being drained, making apparatus 10 available for immediate use, night or day. Switch 48 also permits apparatus 10 to be moved from one facility to another without a load remaining on battery 24.

Keypad 38 permits information to be input into CPU 22 prior to the use of apparatus 10. Preferably, keypad 38 is of membrane-type for weather resistance. Keypad 38 has four, buttons, each of which being respectively marked with indicia that designate NEXT, UP, DOWN and ENTER functions within CPU 22. By pressing various combinations of buttons, a user can set various parameters in CPU 22 for the actuation of solenoid valve 30.

LCD display 40 connected to CPU 22 permits a user to visually confirm the selected parameters under which solenoid valve 30 operates. Preferably, display 40 presents two lines of twenty characters for optimum data transmission to a user. Display 40 can be backlit for nighttime viewing.

CPU 22 is a conventional microprocessor within which is stored a program for operating shut-in valve 12. To use the program, several pieces of information must be provided to CPU 22 via keypad 38. Among the information required is: 1) low pressure limit, 2) high pressure limit, 3) maximum operating pressure, 4) operating range of pressure transducer 20, 5) automatic reset pressure, and 6) time delay for the actuation of shut-in valve 12. When compressed gas is supplied to pressure switch 48, CPU 22 is energized so as to cause a prompt for information to appear on display 40.

By selectively depressing the four buttons on keypad 38, information is entered into CPU 22 where it is stored in memory for future reference. The UP and DOWN buttons are used to increase or decrease numerical inputs and toggle between the activation and deactivation of different functions. The ENTER selects and stores a piece of information produced by using the UP and DOWN buttons. Depressing the NEXT button permits a user to skip from one requested piece of information to the next. All requests for information and the user-supplied information itself are sequentially shown on display 40 at the command of CPU 22.

After all required information is input into CPU 22, CPU 22 causes display 40 to continuously show information about the operation of apparatus 10. Preferably, the following information is sequentially displayed: 1) pressure detected by transducer 20, voltage of battery 24, maximum operating pressure, override (enabled/disabled), auto-reset (enabled/disabled), and time delay (enabled/disabled).

If the pressure sensed by transducer 20, falls outside the operating range bounded by the low and high pressure limits input by the user into CPU 22, shut-in valve 12 will be closed in the manner described above and the limit exceeded will be shown on display 40. At this point, the user can correct the problem that led to the abnormal pressure or “override” apparatus 10 by reopening shut-in valve 12. If such an action is believed to be safe, it is undertaken simply by pressing the buttons of keypad 40 in a manner that enables the override. With the override function enabled, CPU 22 continues to monitor for exceedences of the input maximum operating pressure. If the maximum operating pressure, as sensed by transducer 20, is exceeded, CPU 22 will again cause shut-in valve 12 to close.

In the event that shut-in valve 12 is closed because transducer sensed a pressure that exceeded the high pressure limit input by a user into CPU 22, an auto-reset function can be enabled via keypad 38 that reopens shut-in valve 12 automatically once the pressure has decreased to a predetermined point below the high pressure limit. If the pressure sensed by transducer 20 fell below the low pressure limit for flow through flow line 14 (a typical leak indicator), the auto-reset feature will not function to open shut-in valve 12.

Should transducer 20 ever sense that the maximum operating pressure has been exceeded, CPU 22 closes shut-in valve 12 in a manner that cannot be auto-reset. The user can now only reopen shut-in valve 12 if the pressure sensed by transducer 20 is within the range established by the user-set low and high pressure limits and the maximum operating pressure is reentered into keypad 38 when prompted by an indication on display 40 to show that the user understands the gravity of the situation.

CPU 22 permits shut-in valve 12 to be closed after a brief time delay to ensure that a pressure sensed by transducer 20 really exceeds the preset high or low pressure operating limit input by the user into CPU 22 in a manner that can cause harm or merely involves a temporary operating perturbation. If enabled by use of appropriate keypad 38 inputs, the time delay feature recognizes a limit exceedence and takes 30 pressure readings from transducer 20 at 500 ms intervals. If the average of the 30 pressure readings exceeds either the set high or low pressure limit, shut-in valve 12 will be closed. In the end, the time delay feature provides about a 10 to 12 second confirmation period within which an authoritative decision can be made regarding the propriety of closing shut-in valve 12.

From the foregoing, it should be appreciated that apparatus 10 provides an automatic means for closing a shut-in valve 12 connected to a pressurized flow line 14 that can be operated virtually anywhere an unobstructed view of the sun can be obtained. Apparatus 10 is easy to set up and operate and can be overridden in the presence of a user where safety is assured. After use of apparatus 10 is no longer required in one location, apparatus 10 can be transported to a new location with ease and reused.

While the invention has been described with a high degree of particularity, it will be appreciated by those skilled in the art that modifications may be made to it. For example, one or more normally open switches as at 52 can be operatively connected to CPU 22 to monitor other aspects of the system associated with delivering fluid through flow line 14 from source 16 to receiver 18. Should switch 52, monitoring the fluid level in a tank or the pressure within a vessel, close upon exceeding a preset threshold limit, an electrical current will flow through switch 52 thereby sending a signal to CPU 22. CPU 22 will, in turn, cause shut-in valve 12 to close, protecting life and property. Therefore, it is to be understood that the present invention is not limited to the sole embodiment described above, but encompasses any and all embodiments within the scope of the following claims.

I claim:

1. A flow control apparatus, comprising
a housing having an enclosure and a lid being hingedly attached to said enclosure so as to cover the top of said enclosure;
a device being remote from said housing and having first and second operating states;
a CPU being positioned within said enclosure and being adapted to toggle said remote device between said first and second operating states;
a sensor being connected to a system of which said remote device forms a part for conveying to said CPU information about an operating characteristic of said system;
a keypad being mounted atop said enclosure for inputting the preferred operating parameters of said system into said CPU;
a display being mounted atop said enclosure adjacent said keypad for visually confirming the operating parameters of said system input into said CPU; and,
a solar panel being mounted atop said lid for powering: said CPU, said sensor, said keypad, and said display;
whereby, in response to receiving information from said sensor, said CPU determines whether the operating characteristic described by the information falls within the preferred operating parameters input into said CPU and, if not, said CPU toggles said device from said first to said second operating state.

2. A flow control apparatus, comprising:
a shut-in valve for regulating the passage of a fluid through a flow line;
a weather-resistant housing being positioned at a distance from said shut-in valve, said housing having an enclosure and a lid being hingedly attached to said enclosure so as to cover the top of said enclosure;
a CPU being positioned within said enclosure and being adapted to remotely control said shut-in valve;
a pressure transducer being positioned within said enclosure and being in fluid communication with the fluid in the flow line for sending to said CPU an electrical signal proportional to the pressure of the fluid;
a keypad being mounted atop said enclosure for inputting a pressure range into the memory of said CPU;
an LCD display being mounted atop said enclosure adjacent said keypad for visually confirming the pressure range input into said CPU; and,
a solar panel being mounted atop said lid for powering: said CPU, said pressure transducer, said keypad, and said LCD display;
whereby, in response to receiving a signal from said pressure transducer, said CPU determines whether the pressure represented by the signal falls within the pressure range input into the CPU and, if not, said CPU closes said shut-in valve.

3. The flow control apparatus, comprising:
a shut-in valve for regulating the passage of a fluid through a flow line, said shut-in valve being open only when charged with compressed gas;
a weather-resistant housing being positioned at a distance from said shut-in valve, said housing having an enclosure and a lid being hingedly attached to said enclosure so as to cover the top of said enclosure;
a solenoid valve being positioned within said housing for delivering compressed gas to said shut-in valve when opened and draining compressed gas from said shut-in valve when closed;
a CPU being positioned within said enclosure and being adapted to control said solenoid valve;
a pressure transducer being positioned within said enclosure and being in fluid communication with the fluid in the flow line for sending to said CPU an electrical signal proportional to the pressure of the fluid;
a keypad being mounted atop said enclosure for inputting a pressure range into the memory of said CPU;
a display being mounted atop said enclosure adjacent said keypad for visually confirming the pressure range input into said CPU; and,
a solar panel being mounted atop said lid for powering: said solenoid valve, said CPU, said pressure transducer, said keypad, and said display;
whereby, in response to receiving a signal from said pressure transducer, said CPU determines whether the pressure represented by the signal falls within the pressure range input into the CPU and, if not, said CPU closes said solenoid valve and, hence, said shut-in valve.
